(19) United States
(12) Patent Application Publication
(10) Pub. No.: US 2019/0102705 A1
(43) Pub. Date: Apr. 4, 2019

(54) Determining Preferential Device Behavior

(71) Applicant: Apple Inc., Cupertino, CA (US)

(72) Inventors: Lukas M. Marti, Santa Clara, CA (US); Ronald Keryuan Huang, San Jose, CA (US); Shannon M. Ma, San Francisco, CA (US)

(73) Assignee: Apple Inc., Cupertino, CA (US)

(21) Appl. No.: 16/184,946

(22) Filed: Nov. 8, 2018

Related U.S. Application Data
(63) Continuation of application No. 13/783,195, filed on Mar. 1, 2013.
(60) Provisional application No. 61/724,861, filed on Nov. 9, 2012.

(51) Int. Cl. G06N 99/00

(52) U.S. Cl. CPC G06N 99/005

(57) ABSTRACT

Systems, methods and computer program products are disclosed for machine learning to determine preferential device behavior. In some implementations, a server receives inputs, including attributes from a client device, crowd-sourced data from a number of other devices and a priori knowledge. The server includes a concept engine that applies machine-learning process to the inputs. The output of the machine learning process is transported to the client device. At the client device, a client engine associates attributes observed at the device to the machine learning output to determine a user profile. Applications may access the user profile to determine preferential device behavior, such as provide targeted information to the user or take action on the device that is personalized to the user of the device.

### CROSS-REFERENCE TO RELATED APPLICATION

This application claims priority to U.S. Provisional Application No. 61/724,861, entitled “Machine Learning to Determine Preferential Device Behavior,” filed on Nov. 9, 2012, the entire contents of which are incorporated herein by reference.

### TECHNICAL FIELD

This disclosure is related generally to machine learning system architectures for devices.

### BACKGROUND

Machine learning algorithms process empirical data (e.g., sensors, databases) and provide patterns or predictions about features of the underlying system that generated the empirical data. A focus of machine learning research is the design of algorithms that recognize complex patterns and make intelligent decisions based on input data. One fundamental difficulty with machine learning is that the set of all possible behaviors given all possible inputs is too large to be included in the set of observed examples or training data. Accordingly, the learning algorithm must generalize from the examples or training data to produce a useful output in new cases.

### SUMMARY

Systems, methods and computer program products are disclosed for machine learning to determine preferential device behavior. In some implementations, a server receives inputs, including attributes from a client device, crowd-sourced data from a number of other devices and prior (a priori) knowledge. The server includes a concept engine that applies a machine-learning process to the inputs. The output of the machine learning process is transported to the client device. At the client device, a client engine associates attributes observed at the device to the machine learning output to determine a user profile. Applications may access the user profile to determine preferential device behavior, such as provide targeted information to the user or take action on the device that is personalized to the user of the device.

Other implementations are directed to systems, computer program products, and computer-readable mediums.

Particular implementations disclosed herein provide one or more of the following advantages. A user's device may be personalized based on observations of the user's behavior and profile classes or clusters derived from a machine learning process. The user's experience with the device is enriched because the device adapts to the specific preferences of the user and not to a category of users.

The details of the disclosed implementations are set forth in the accompanying drawings and the description below. Other features, objects, and advantages will be apparent from the description and drawings, and from the claims.

### DESCRIPTION OF DRAWINGS

FIG. 1 is a block diagram of an exemplary system for machine learning.

FIG. 2 is a block diagram of an exemplary server for machine learning.

FIG. 3 is a block diagram of an exemplary concept engine.

FIG. 4 is a block diagram of an exemplary concept descriptor.

FIG. 5 is a block diagram of exemplary concept learning for personal regions.

FIG. 6 is a block diagram of exemplary concept learning for tourist point of interest (POI).

FIG. 7A is a block diagram of exemplary concept learning for user mood.

FIG. 7B is an exemplary decision tree for the user mood concept.

FIG. 8 is a block diagram of an exemplary client device functions for machine learning.

FIG. 9 is a flow diagram of an exemplary machine learning process performed by a client device.

FIG. 10 is a flow diagram of an exemplary machine learning process performed by a server.

FIG. 11 is a block diagram of an exemplary architecture for a client device for machine learning.

FIG. 12 is a block diagram of an exemplary architecture for a server for machine learning.

The same reference symbol used in various drawings indicates like elements.

### DETAILED DESCRIPTION

### Exemplary System for Machine Learning

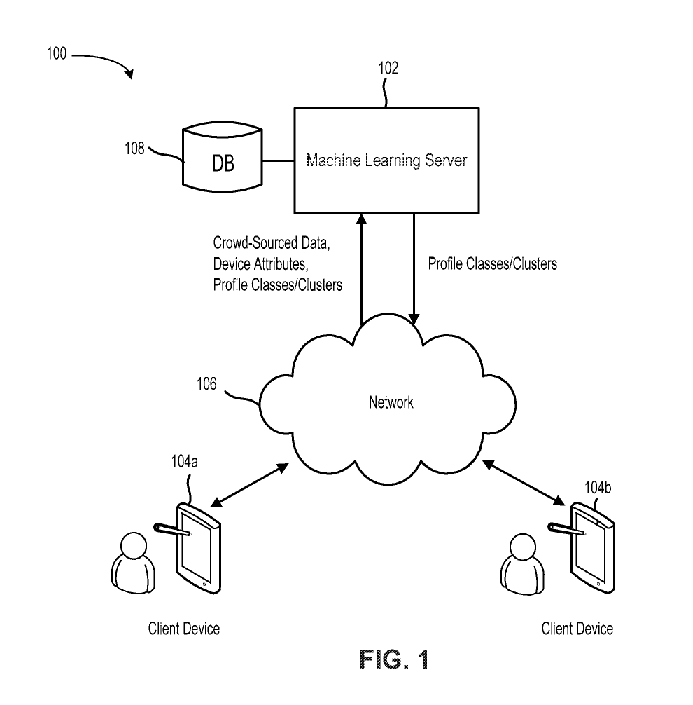

FIG. 1 is a block diagram of an exemplary system 100 for machine learning. In some implementations, system 100 may include server 102 and client devices 104 coupled together by network 106. Server 102 may be configured to receive specific attributes observed at a device and crowd-sourced data from a number of other devices and use the attributes and data in a machine learning process. Server 102 may include one or more server computers and other equipment for transporting output from the machine learning processes to client devices 104. The information may include the results of supervised or unsupervised learning, including but not limited to profile classes or clusters.

Supervised learning is the task of inferring a function from labeled training data. The training data includes an input object (e.g., a feature vector) and a corresponding desired output value called a supervisory signal. A supervised learning process analyzes the training data and produces an inferred function, which is called a classifier. The inferred function should predict the correct output value for any valid input object. This requires the supervised learning process to generalize from the training data to new situations. Some examples of supervised learning processes include but are not limited to: analytical learning, artificial neural networks, boosting (meta-algorithm), Bayesian statistics, decision tree learning, decision graphs, inductive logic programming, Naïve Bayes classifier, nearest neighbor algorithm and support vector machines.

Unsupervised learning refers to the problem of trying to find hidden structure in unlabeled data. Clustering analysis is the assignment of a set of observations into subsets (called clusters) so that observations within the same cluster are similar according to some pre-designated criterion or criteria, while observations drawn from different clusters are dissimilar. Different clustering techniques make different assumptions on the structure of the data, often defined by some similarity metric and evaluated for example by internal compactness (similarity between members of the same cluster) and separation between different clusters. Some examples of unsupervised learning processes include but are not limited to: clustering (e.g., k-means, mixture models, hierarchical clustering), blind signal separation using feature extraction techniques for dimensionality reduction (e.g., principal component analysis, independent component analysis, non-negative matrix factorization, singular value decomposition) and artificial neural networks (e.g., self-organizing map, adaptive resonance theory).

Regardless of the machine learning process, the output values of the machine learning process may be stored in database 108, which is accessible to server 102 and may be made accessible to client devices 104 through server 102.

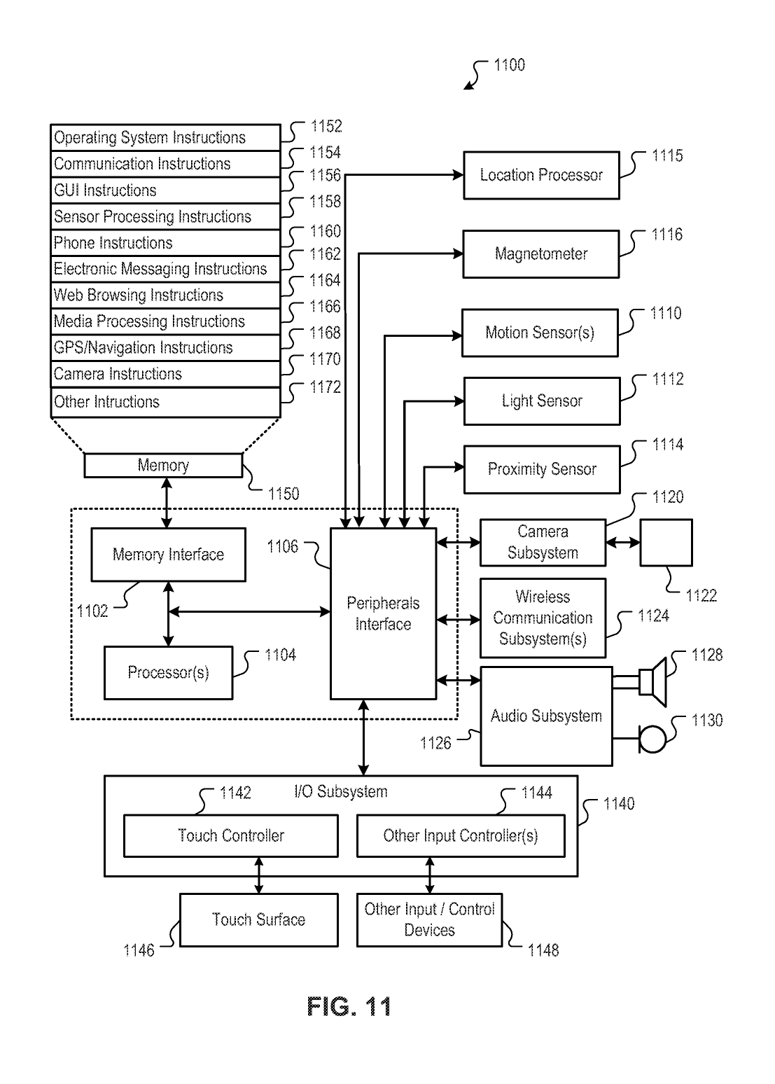

Client devices 104 may be any device capable of processing data. Client devices 104 may communicate with server 102 through various wired (e.g., Ethernet) or wireless connections (e.g., WiFi, cellular) to network 106. Client devices 104 may include a variety of sensors that provide data that may be input to a machine learning process, as described in reference to FIG. 11. Some examples of client devices 104 include but are not limited to personal computers, smart phones and electronic tablets.

Network 106 may be a collection of one or more networks that include hardware (e.g., router, hubs) and software configured for transporting information from one device to another device. Some examples of network 106 are Local Area Networks (LAN), Wide Area Networks (WAN), Wireless LAN (WLAN), Internet, intranets, cellular networks and the Public Switched Telephone Network (PSTN).

### Exemplary Server for Machine Learning

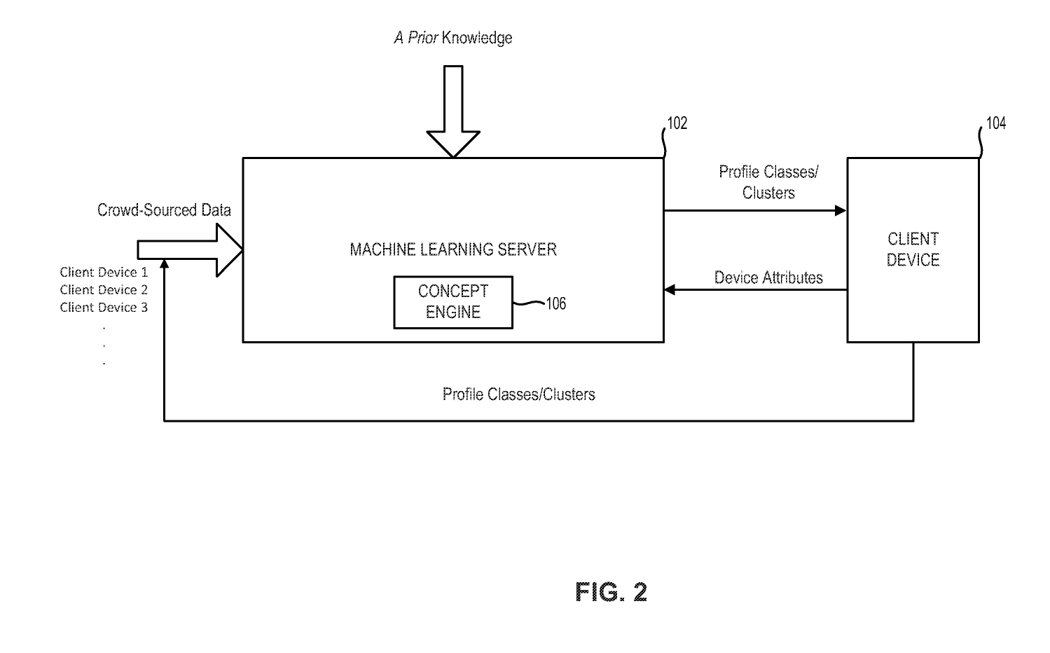

FIG. 2 is a block diagram of an exemplary server 102 for machine learning. In some implementations, server 102 includes concept engine 106, which may be a software and/or hardware module configured to implement a machine learning process. Machine learning server 102 may be configured to receive crowd-sourced data, a priori knowledge, device attributes and profile classes, and to derive profile classes or clusters based on these inputs using a machine learning process.

The following example illustrates machine-learning system 100. A number of individuals are visiting a shopping mall on a regular basis. An individual may have a number of reasons for visiting the shopping mall. Some individuals are mall employees. Some individuals are shoppers who want to buy some specific product or service. Some individuals are looking for a some good deals but do not have a specific product or service to buy. Finally, some shoppers are going to see a movie at theatre at the mall. Each of these categories of individuals may be associated with different interests. The category of individuals going to the mall to see a movie may be interested in movie start times. The category of individuals going to the mall to shop may be interested in available coupons/deals. Machine learning system 100 is configured to adapt the user's device (e.g., smart phone, electronic tablet) to the individual preferences of the user rather than deriving a median behavior model, such as the behavior of a set of all people visiting the mall.

Machine learning system 100 establishes a set of profile classes (supervised learning) or clusters (unsupervised learning) and associates individual users to the profile classes or clusters based on observations made at the users' devices through sensors on the device (e.g., motion sensors, light sensors, microphones), time of events, location of events or actions taken by the user (e.g., Web search history, context of applications running on device, telephone call logs, text messages, email, home region of device).

Referring to the mall example, based on the observation that an individual is arriving at the mall before the opening time for several consecutive days infers that the individual belongs to the mall employee category. Once the user has been associated to the “Mall Employee” category, the user's device may be adapted to the category.

Machine learning system 100 allows client devices 104 to be associated to profile classes/clusters. System 100 derives different classes/clusters on server 102 from a crowd-sourced data provided by a large number of client devices 104. Client devices 104 download profile classes/clusters from server 102 and run machine-learning processes on observations made at client devices 104. Client devices 104 associate specific user behavior observed at client devices 104 to one or more profile classes/clusters. Preferential device behavior is derived that is fundamental to the one or more associated profile classes. Client devices 104 are configured or adapted according to the preferential device behavior.

For another example, through continued use of client device 104a, client device 104a may learn about the home region of the user. A home region is geographic area where a user lives. It may be a neighborhood, region, city, state or country. Client device 104a may also learn about the language being used in the home region. When the user exits the home region (e.g., by exiting a geofence established around the user's home region), device 104a may provide sightseeing recommendations, foreign call-roaming charges and any other information specific to the user's home region. As soon as the user enters his home region, a wake-up alarm correlated to a previous alarm setting behavior could be suggested to the user. When sending messages to people in the home region, client device 104a may adapt text message language to the language spoken in the home region.

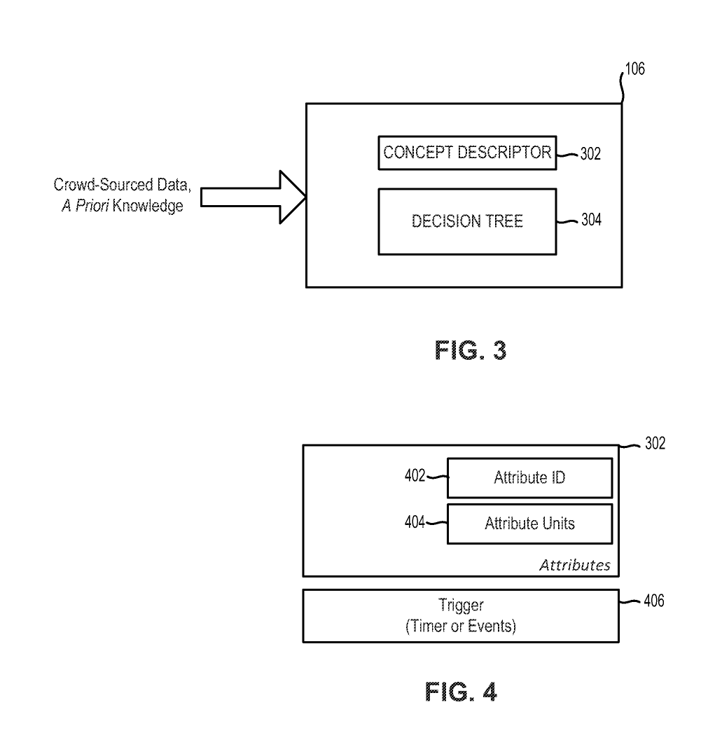

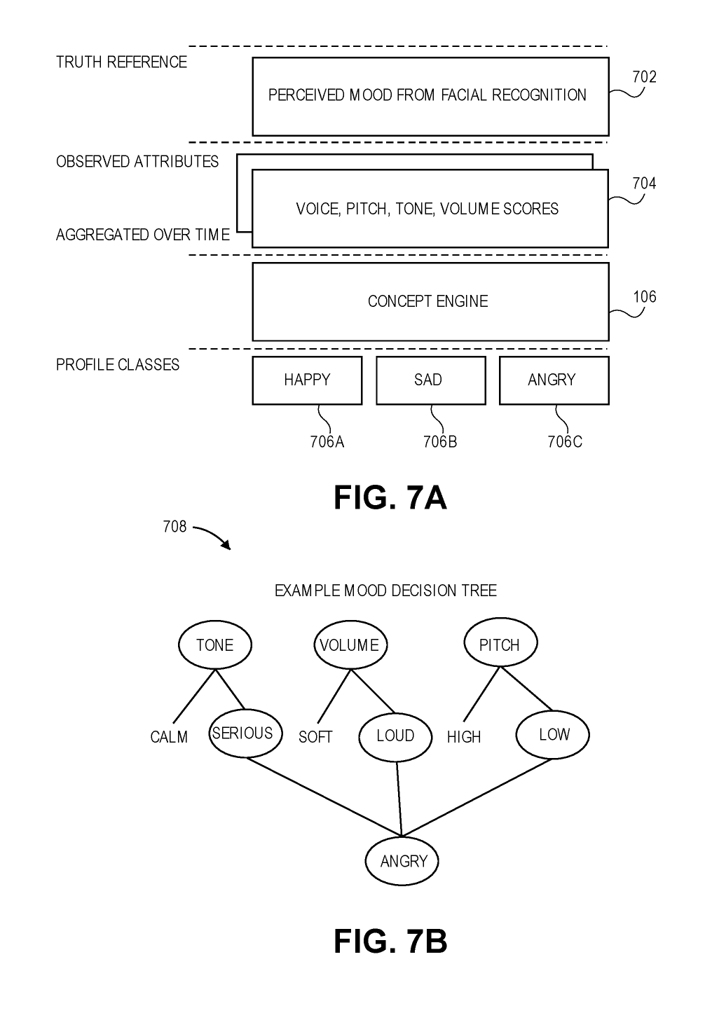

FIG. 3 is a block diagram of an exemplary concept engine 106. In some implementations, concept engine 106 may include concept descriptor 302 and decision tree 304. A concept defines what is to be learned by the machine learning process. Some examples of concepts are interests (e.g., baseball, food, cars), mood (e.g., happy, sad, angry) and restaurants (e.g., French, Japanese, Mexican, Italian). Decision tree 304 may be dynamically programmed with crowd-sourced data. For example, facial expression and voice statistics generated derived from crowd-sourced data may be used to dynamically program decision tree 304 for a mood concept, as illustrated in FIG. 7B.

FIG. 4 is a block diagram of an exemplary concept descriptor 302. Concept descriptor 302 defines inputs to a machine learning process for a particular concept. Concept descriptor 302 may include attribute identifier (ID) 402 and attribute units 404. Attribute ID 402 may be used to identify an attribute unit 404. Attribute units 404 may include a single sample captured in response to a trigger event or multiple samples aggregated over a period time (e.g., over a week) tracked by a timer on client device 104. For example, for a “mood” concept inputs could include the user's voice pitch, tone and volume (intensity) data captured during a telephone call event. This voice data may be derived from the user's speech during the telephone call using known speech detection and/or recognition techniques. An example of a priori knowledge for a “mood” concept is voice profiles that include relative values for pitch, tone and volume (intensity).

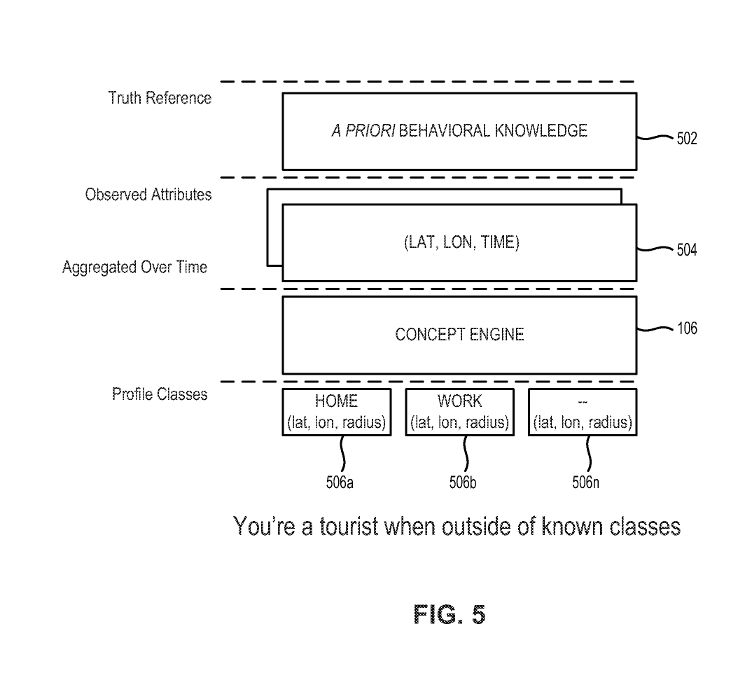

FIG. 5 is a block diagram of exemplary concept learning for personal regions. In this example, to objective is to determine when a user is outside a personal region. An example of a personal region may be a home region or work region. A region may be defined by a virtual geofence surrounding the user's home address or work address. In this example, a truth reference may be a priori behavioral knowledge 502. This may be based on addresses in a contact database for the user's home and work address and a given radius around those addresses that the user has previously defined as their home and work regions. For example, a home region could include the surrounding neighborhood within a certain radial distance from the home address. Similarly, a work region may include an entire company site.

The attributes 504 observed at client device 104 may be geographic coordinates such as the latitude and longitude of the current position of the device and an associated timestamp. The coordinates maybe provided by a variety of positioning technologies, including but not limited to Global Navigation Satellite Systems (GNSS) such as Global Positioning System (GPS), or terrestrial wireless positioning systems using WiFi or cell tower radio frequency signals. These attributes may be aggregated over time.

Concept engine 106 running on machine learning server 102 may use decision tree 304 and dynamic programming to derive the profile classes Home class 506a, Work class 506b and any other class 506n associated with a personal region. For example, decision tree 304 may be programmed with the coordinates and radius of the user's home and work regions. If the current location of client device 104 falls outside both the home and work regions, the user may be deemed a tourist and the preferential device behavior may be configured or adapted for a tourist. For example, client device 104 may provide sightseeing recommendations.

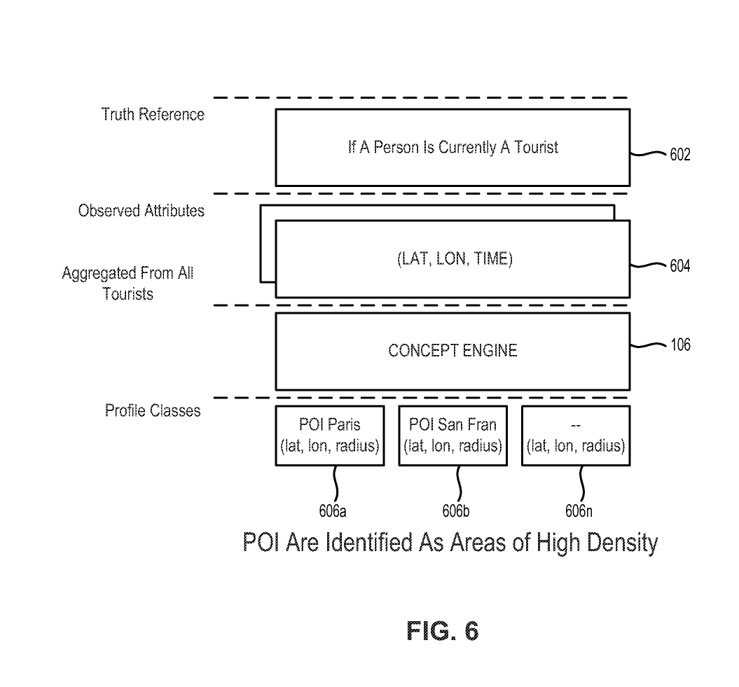

FIG. 6 is a block diagram of exemplary concept learning for tourist point of interest (POI). In this example, truth reference 602 is that the user is already deemed a tourist. Attributes 604 (e.g., geographic coordinates) from a large number of tourists (crowd-sourced data) are used by concept engine 106 to derive classes for POIs. In the example shown, concept engine 106 derives Paris class 606a and San Francisco class 606b based on attributes 604. Other classes 606n are also possible.

FIG. 7A is a block diagram of exemplary concept learning for user mood. In this example, a truth reference may be a perceived mood of the user. If the client device has an embedded camera, then the perceived mood may be determined using facial recognition technology. For example, an image of the user's face may be captured by the camera and various facial landmarks may be analyzed using facial recognition technology to determine the user's mood. At the device, the user's speech may be analyzed using speech recognition technology to determine the user's mood. The analysis may occur, for example, while the user is participating on a telephone call. Other opportunities for capturing speech samples, include voice commands for voice activated services and recording applications. Various speech characteristics may be sampled over a period of time (e.g., pitch, tone, intensity) and scores may be assigned to a running average of the samples. The scores may be compared against threshold values, which can be determined empirically. Based on results of the comparing, the user's mood may be determined. For example, each characteristic may be assigned a value in a range between one and ten.

FIG. 7B is an exemplary decision tree for the user mood concept of FIG. 7A. The first or top level of the tree includes the speech characteristics tone, volume and pitch. At the second level, scores were analyzed and it was determined that the tone was “serious,” the volume was “loud” and the pitch was “low.” At the third or bottom level of the tree, the combination of the serious tone, the loud volume and the low pitch, predicts that the user's mood is “angry.” Although this example was simplistic, the reader should understand that the concept illustrated in FIG. 7B may be extended to any size decision tree and may include more or fewer speech characteristics. The decision tree may be programmed using dynamic programming or any other known, suitable method.

Using another example, a concept can be “sports.” The objective may be to develop a profile class for sports. If the client device is a smart phone, an example decision tree for a sports concept may include observation of the sports applications that the user installed on the client device and a Web search history for a Web browser. By looking at the types of sport applications installed and the types of sports websites visited by the user, a profile class for the user for sports can be determined. For example, if the user downloaded football applications and frequently visited football related websites, the profile class for sports for the user would include football.

### Exemplary Client Device for Machine Learning

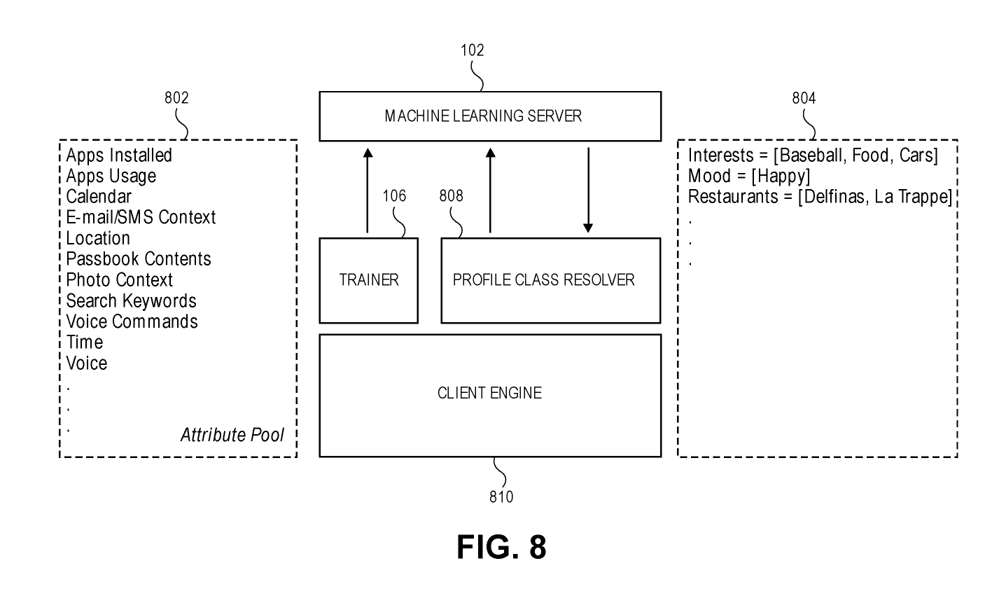

FIG. 8 is a block diagram of an exemplary client device 104 for machine learning. In some implementations, client device 104 may include trainer module 806, profile class resolver 808 and client engine 810. Trainer module 806 and profile class resolver 808 communicate with machine learning server 102 using known client/server protocols (e.g., TCP/IP, HTTP, XML).

Client engine 801 has access to a set of observed attributes stored on client device 104. The attributes are pooled together in memory in attribute pool 502. The attributes may be derived from sensor data or from actions taken by the user over time. For a smart phone, these attributes may include but are not limited to: the types of applications installed, the use of the applications, calendar entries, e-mail/SMS context, location, ticket purchases, photo context, search keywords, voice commands, time speech characteristics and any other attributes that may be observed by client device 104 and that may be used to resolve a profile class.

Client engine 810 dynamically resolves all concepts and their required attributes. Profile class resolver 808 submits attributes for concepts a defined by triggers and behavior classed received from machine learning server 102. Output of profile class resolver 808 is user profile 804. User profile 804 may be used by applications to determine preferential device behavior. Client device 104 may be adapted according to the preferential device behavior or an action may be initiated on client device 104 based on the preferential device behavior.

Trainer module 806 formats profile classes into training data (e.g., feature vectors) that is suitable to be processed by machine learning processes implemented by server 102.

### Exemplary Client Process for Machine Learning

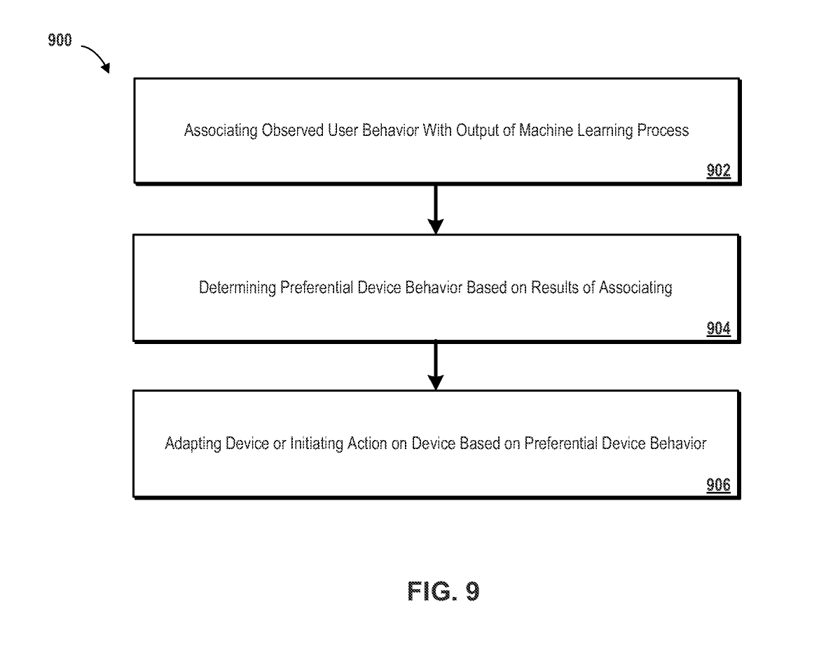

FIG. 9 is a flow diagram of an exemplary machine learning process 900 performed by a client device. Process 900 may be performed using client device architecture 1100.

In some implementations, process 900 may begin by associating observed user behavior with output of a machine learning process (902). The output is derived from attributes observed at the client device and attributes observed from a number of other devices (e.g., crowd-sourced data). Process 900 may continue by determining a preferential device behavior based on results of the associating (904). For example, observed behaviors at the client device can be compared with profile classes derived by a machine-learning server 102, as described in reference to FIGS. 1-8. Process 900 may continue by adapting the client device or initiating an action on the client device based on the preferential device behavior (906). For example, a user profile may be created on the client device that may be used to personalize device settings according to, for example, the user's interests or mood. Additionally, information or content displayed, played, or otherwise presented by or on the device may be personalized to the user's interests, mood, etc.

### Exemplary Server Process for Machine Learning

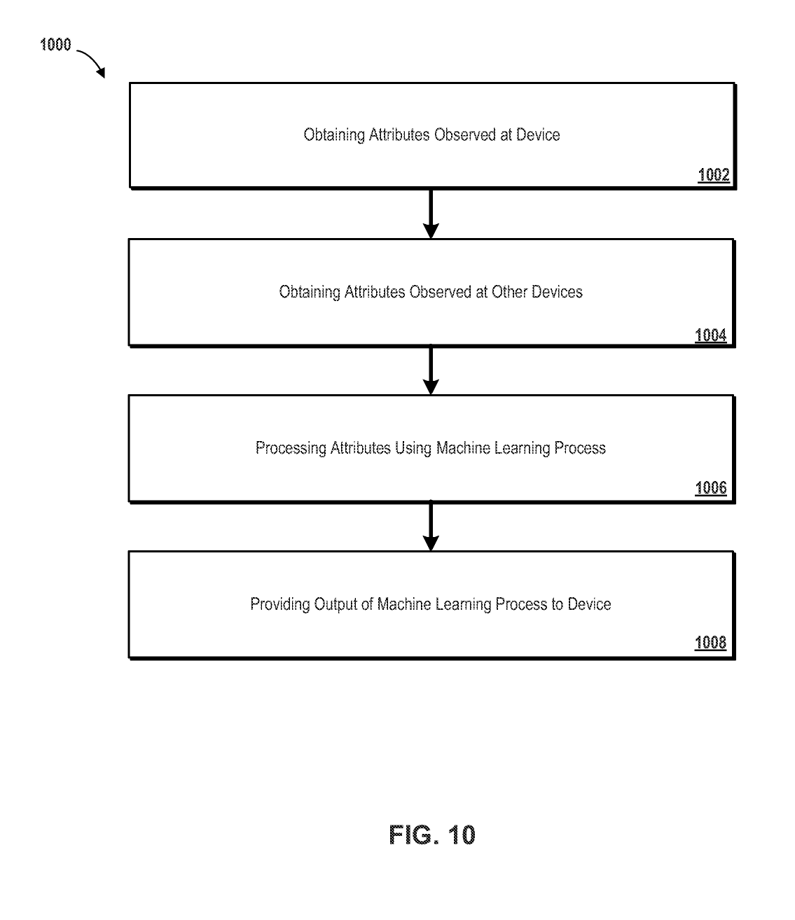

FIG. 10 is a flow diagram of an exemplary machine learning process 1000 performed by a server. Process 1000 may be performed using server architecture 1200.

Process 1000 may begin by obtaining attributes observed at a device (1002). Some examples of attributes are applications install and/or used, calendar entries, e-mail/SMS context, location, photo context, search keywords, voice commands, time and any other attributes that can be used to determine the user's interests or mood.

Process 1000 may continue by obtaining attributes from a number of other devices (1004). For example, observed attributes and/or profile classes from other devices (e.g., crowd-sourced data) can be processed by machine learning server 102 to provide updates or new profile classes to client device 104.

Process 1000 may continue by processing the attributes using a machine learning process (1006). The machine learning process can be supervised or unsupervised. Process 1000 may continue by providing output of the machine learning process to the device (1008). The output can be profile classes that associated with concepts. Some examples of concepts are interests, mood, personal region, tourist POIs and restaurants. Other concepts are also possible.

### Exemplary Client Device Architecture

FIG. 11 is a block diagram of exemplary architecture 1100 for client devices 104a, 104b. Architecture 1100 may be implemented in any device capable of performing process 1100, as described in reference to FIG. 11, including but not limited to portable or desktop computers, smart phones and electronic tablets and the like.

Architecture 1100 may include memory interface 1102, data processor(s), image processor(s) or central processing unit(s) 1104, and peripherals interface 1106. Memory interface 1102, processor(s) 1104 or peripherals interface 1106 may be separate components or may be integrated in one or more integrated circuits. The various components may be coupled by one or more communication buses or signal lines.

Sensors, devices, and subsystems may be coupled to peripherals interface 1106 to facilitate multiple functionalities. For example, motion sensor 1110, light sensor 1112, and proximity sensor 1112 may be coupled to peripherals interface 1106 to facilitate orientation, lighting, and proximity functions of the device. For example, in some implementations, light sensor 1112 may be utilized to facilitate adjusting the brightness of touch surface 1146. In some implementations, motion sensor 1110 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 1106, such as a temperature sensor, a biometric sensor, or other sensing device, to facilitate related functionalities.

Location processor 1115 (e.g., GPS receiver) may be connected to peripherals interface 1106 to provide geo-positioning. Electronic magnetometer 1116 (e.g., an integrated circuit chip) may also be connected to peripherals interface 1106 to provide data that may be used to determine the direction of magnetic North. Thus, electronic magnetometer 1116 may be used as an electronic compass.

Camera subsystem 1120 and an optical sensor 1122, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 1124. Communication subsystem(s) 1124 may include one or more wireless communication subsystems. Wireless communication subsystems 1124 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data. The specific design and implementation of the communication subsystem 1124 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max, 3G, 4G), code division multiple access (CDMA) networks, and a Bluetooth™ network. Communication subsystems 1124 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 1126 may be coupled to a speaker 1128 and one or more microphones 1130 to facilitate voice-enabled functions, such as voice recognition, voice replication, digital recording, and telephony functions.

I/O subsystem 1140 may include touch controller 1142 and/or other input controller(s) 1144. Touch controller 1142 may be coupled to a touch surface 1146. Touch surface 1146 and touch controller 1142 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 1146. In one implementation, touch surface 1146 may display virtual or soft buttons and a virtual keyboard, which may be used as an input/output device by the user.

Other input controller(s) 1144 may be coupled to other input/control devices 1148, such as one or more buttons, rocker switches, thumb-wheel, infrared port, USB port, and/or a pointer device such as a stylus. The one or more buttons (not shown) may include an up/down button for volume control of speaker 1128 and/or microphone 1130.

In some implementations, device 1100 may present recorded audio and/or video files, such as MP3, AAC, and MPEG files. In some implementations, device 1100 may include the functionality of an MP3 player and may include a pin connector for tethering to other devices. Other input/output and control devices may be used.

Memory interface 1102 may be coupled to memory 1150. Memory 1150 may include high-speed random access memory or non-volatile memory, such as one or more magnetic disk storage devices, one or more optical storage devices, or flash memory (e.g., NAND, NOR). Memory 1150 may store operating system 1152, such as Darwin, RTXC, LINUX, UNIX, OS X, WINDOWS, or an embedded operating system such as VxWorks. Operating system 1152 may include instructions for handling basic system services and for performing hardware dependent tasks. In some implementations, operating system 1152 may include a kernel (e.g., UNIX kernel).

Memory 1150 may also store communication instructions 1154 to facilitate communicating with one or more additional devices, one or more computers or servers. Communication instructions 1154 may also be used to select an operational mode or communication medium for use by the device, based on a geographic location (obtained by the GPS/Navigation instructions 1168) of the device. Memory 1150 may include graphical user interface instructions 1156 to facilitate graphic user interface processing; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GPS/Navigation instructions 1168 to facilitate GPS and navigation-related processes; camera instructions 1170 to facilitate camera-related processes and functions; and other instructions 1172 for facilitating other processes, features and applications, such as trainer module 806, behavior class resolver 808 and client engine 810, as described in reference to FIG. 8.

Each of the above identified instructions and applications may correspond to a set of instructions for performing one or more functions described above. These instructions need not be implemented as separate software programs, procedures, or modules. Memory 1150 may include additional instructions or fewer instructions. Furthermore, various functions of the device may be implemented in hardware and/or in software, including in one or more signal processing and/or application specific integrated circuits.

### Exemplary Server Architecture

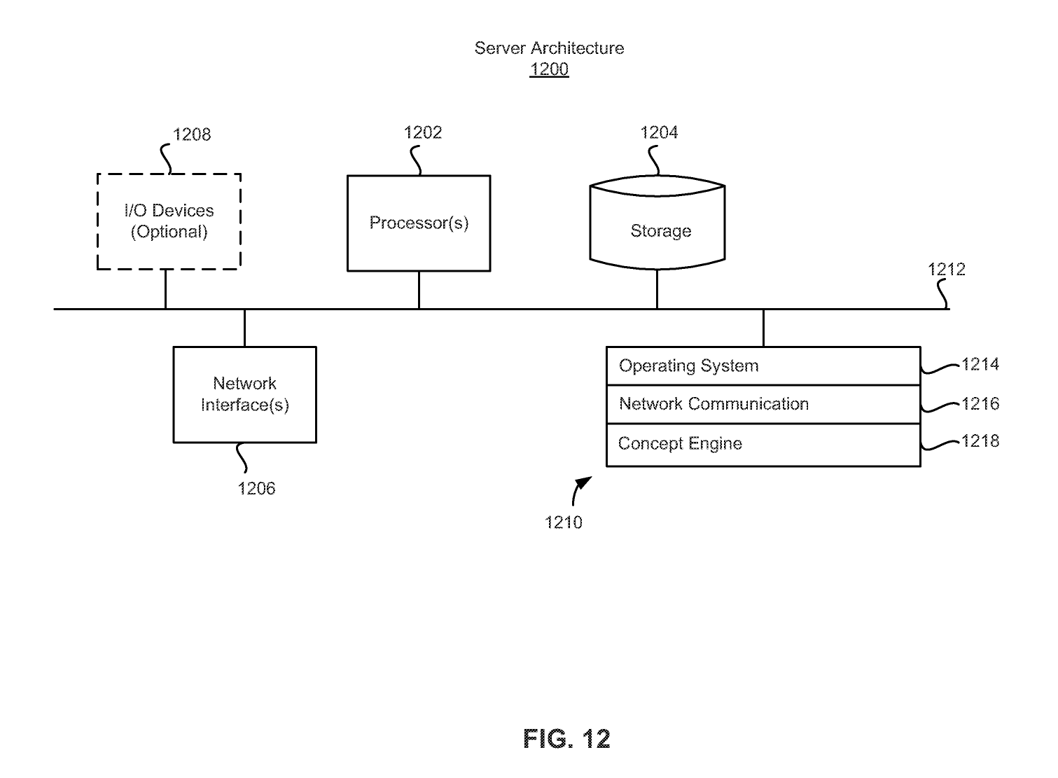

FIG. 12 is a block diagram of exemplary architecture 1200 for machine learning server 102. Architecture 1200 may be implemented on any data processing apparatus that runs software applications derived from instructions, including without limitation personal computers, smart phones, electronic tablets, game consoles, servers or mainframe computers. In some implementations, the architecture 1200 may include processor(s) 1202, storage device(s) 1204, network interfaces 1206, Input/Output (I/O) devices 1208 and computer-readable medium 1210 (e.g., memory). Each of these components may be coupled by one or more communication channels 1212.

Communication channels 1212 may be any known internal or external bus technology, including but not limited to ISA, EISA, PCI, PCI Express, NuBus, USB, Serial ATA or FireWire.

Storage device(s) 1204 may be any medium that participates in providing instructions to processor(s) 1202 for execution, including without limitation, non-volatile storage media (e.g., optical disks, magnetic disks, flash drives, etc.) or volatile media (e.g., SDRAM, ROM, etc.).

I/O devices 1208 may include displays (e.g., touch sensitive displays), keyboards, control devices (e.g., mouse, buttons, scroll wheel), loud speakers, audio jack for headphones, microphones and another device that may be used to input or output information.

Computer-readable medium 1210 may include various instructions 1214 for implementing an operating system (e.g., Mac OS®, Windows®, Linux). The operating system may be multi-user, multiprocessing, multitasking, multithreading, real-time and the like. The operating system performs basic tasks, including but not limited to: keeping track of files and directories on storage devices(s) 1204; controlling peripheral devices, which may be controlled directly or through an I/O controller; and managing traffic on communication channels 1212. Network communications instructions 1216 may establish and maintain network connections with client devices (e.g., software for implementing transport protocols, such as TCP/IP, RTSP, MMS, ADTS, HTTP Live Streaming). Computer-readable medium 1210 may store instructions, which, when executed by processor(s) 1202 implement concept engine 106.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). For example, the data access daemon may be accessed by another application (e.g., a notes application) using an API. An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1.-22. (canceled)

23. A computer-implemented method comprising:
receiving, at a mobile device from a set of one or more server computers, class data representing a plurality classes established by the server based on a machine learning process using crowd-sourced data obtained from a plurality of mobile devices;
gathering, by the mobile device, mobile device user data from at least one or more sensors of the mobile device;
sending, by the mobile device, mobile device user data to the set of one or more server computers, wherein the set of one or more server computers trains a decision tree with the mobile device user data in response to receiving of the mobile user data from the mobile device and derives a set of one or more profile classes from the class data using the decision tree;
receiving, by the mobile device, the set of one or more profile classes from the set of one or more server computers; and
reconfiguring, by the mobile device, the mobile device based on at least the set of one or more profile classes, wherein the reconfiguring of the mobile device includes at least one of adding or changing the information presented to a user of the mobile device based on at least the set of one or more profile classes.

24. The computer implemented method of claim 1, wherein the one or more sensors of the mobile device are each selected from the group consisting of a location sensor, motion sensor, magnetometer, light sensor, proximity sensor, and camera sensor.

25. The computer implemented method of claim 1, wherein the mobile device user data further includes one or more of time of events, location of events taken by the user, installed applications on the mobile device, or use of the installed applications.

26. The computer-implemented method of claim 1, further comprising:
determining, by the mobile device, a truth reference from any one or more of the mobile device user data and one or more of the plurality classes that associated with the mobile device, wherein the server incorporates the truth reference into the decision tree.

27. The computer-implemented method of claim 4, further comprising:
Determining, by the mobile device, a truth reference from a priori knowledge.

28. The computer-implemented method of claim 1, wherein the adding or changing the information presented to a user of the mobile device includes one or more of presenting suggestions or changing a presentation language.

29. The computer-implemented method of claim 1, wherein the machine learning process is selected form the group consisting of supervised learning and unsupervised learning.

30. The computer-implemented method of claim 7, wherein the supervised learning is inferring a function from labeled training data.

31. The computer-implemented method of claim 7, wherein the supervised learning is inferring a function from labeled training data.

32. The computer-implemented method of claim 1, wherein the plurality of classes can relate to any one or more of work, interests and geographical regions derived from the crowd-sourced data.

33. A non-transitory machine-readable medium storing program instructions that, when executed, cause a data processing system to perform a method for determining preferential device behavior, the method comprising:
receiving, at a mobile device from a set of one or more server computers, class data representing a plurality classes established by the server based on a machine learning process using crowd-sourced data obtained from a plurality of mobile devices;
gathering, by the mobile device, mobile device user data from at least one or more sensors of the mobile device;
sending, by the mobile device, mobile device user data to the set of one or more server computers, wherein the set of one or more server computers trains a decision tree with the mobile device user data in response to receiving of the mobile user data from the mobile device and derives a set of one or more profile classes from the class data using the decision tree;
receiving, by the mobile device, the set of one or more profile classes from the set of one or more server computers; and
reconfiguring, by the mobile device, the mobile device based on at least the set of one or more profile classes, wherein the reconfiguring of the mobile device includes at least one of adding or changing the information presented to a user of the mobile device based on at least the set of one or more profile classes.

34. The non-transitory machine-readable medium of claim 11, wherein the one or more sensors of the mobile device are each selected from the group consisting of a location sensor, motion sensor, magnetometer, light sensor, proximity sensor, and camera sensor.

35. The non-transitory machine-readable medium of claim 11, wherein the mobile device user data further includes one or more of time of events, location of events taken by the user, installed applications on the mobile device, or use of the installed applications.

36. The non-transitory machine-readable medium of claim 11, further comprising:
determining a truth reference from any one or more of the mobile device user data and one or more of the plurality classes that associated with the mobile device, wherein the set of one or more server computers incorporates the truth reference into the decision tree.

37. The non-transitory machine-readable medium of claim 14, further comprising:
determining a truth reference from a priori knowledge.

38. The non-transitory machine-readable medium of claim 11, wherein the adding or changing the information presented to a user of the mobile device includes one or more of presenting suggestions or changing a presentation language.

39. The non-transitory machine-readable medium of claim 11, wherein the machine learning process is selected form the group consisting of supervised learning and unsupervised learning.

40. The non-transitory machine-readable medium of claim 17, wherein the supervised learning is inferring a function from labeled training data.

41. The non-transitory machine-readable medium of claim 17, wherein the supervised learning is inferring a function from labeled training data.

42. The non-transitory machine-readable medium of claim 11, wherein the plurality of classes can relate to any one or more of work, interests and geographical regions derived from the crowd-sourced data.
